(19) United States
(12) Patent Application Publication
(10) Pub. No.: US 2023/0106388 A1
(43) Pub. Date: Apr. 6, 2023

(54) ACOUSTIC DEVICE

(71) Applicant: ROHM Co., LTD., Kyoto (JP)

(72) Inventor: Takashi Naiki, Kyoto (JP)

(21) Appl. No.: 17/933,925

(22) Filed: Sep. 21, 2022

(30) Foreign Application Priority Data
Oct. 5, 2021 (JP) 2021-164238

(51) Int. Cl. H04R 1/10; H04R 3/00

(52) U.S. Cl. CPC H04R 1/1016; H04R 1/1025; H04R 1/1066; H04R 3/00; H04R 2201/10

(57) ABSTRACT

Provided is an acoustic device to be worn on an ear for use, the acoustic device including a nozzle having a transducer installed therein, the transducer serving as a sound source, and a housing attached to a base portion of the nozzle and having an electronic circuit and a battery housed therein, the electronic circuit being configured to drive the transducer. When the acoustic device is worn on the ear with a distal end of the nozzle inserted into an earhole and the base portion of the nozzle positioned outside of the earhole, a passage continuously extending between the base portion and the distal end of the nozzle is secured to allow an external sound to be taken in through the passage.

### CROSS REFERENCE TO RELATED APPLICATIONS

This application claims priority benefit of Japanese Patent Application No. JP 2021-164238 filed in the Japan Patent Office on Oct. 5, 2021. Each of the above-referenced applications is hereby incorporated herein by reference in its entirety.

### BACKGROUND

Embodiments of the present technology relate to acoustic devices that are to be worn on ears and that include a transducer to be used as a sound source.

In job sites of the manufacturing industry, medical service, and other industries, augmented reality (AR) has been used to provide operators with human interfaces. In the augmented reality, an operator wears a video device such as a head-mounted display on the head and wears acoustic devices such as earphones on the ears, so that information can be provided to the operator in such a manner as to overlap with the surrounding environment. The operator in operation may desire to hear an external sound such as an alarm or a voice of another person speaking to the operator, and a noise canceling technology and a technique of collecting external sounds through a microphone and reproducing the collected external sounds as adopted in hearing aids are known as methods for allowing such external sounds to be taken in with clear sound quality (see PCT Patent Publication No. WO2017/179409).

Meanwhile, transducers have been provided that are produced by using a micro-electromechanical systems (MEMS) technology which applies a semiconductor manufacturing technology, and that employ a piezoelectric element including a pair of electrodes and a piezoelectric layer held between the pair of electrodes. Loudspeakers including such a transducer have also been provided (see Japanese Patent Laid-open No. 2012-105170).

### SUMMARY

When acoustic devices to be worn are used in the augmented reality in job sites of the manufacturing industry, medical service, and other industries, sound image localization of a sound taken in from the outside, that is, recognition of the direction of the sound source thereof and how far the sound source is, sometimes becomes important. This requires the sound to be taken in with high sound quality while allowing a phase difference of the sound coming from the outside and reaching both ears to be sensed. The sound image localization may be more or less inaccurate when the known noise canceling technology or the known technique of collecting sounds through a microphone and reproducing the collected sounds is employed.

An embodiment of the present technology is proposed in view of the above circumstances, and it is desirable to provide an acoustic device that is to be worn on an ear for use and that allows an external sound to be taken in with high sound quality to enable sound image localization of the external sound taken in.

According to an embodiment of the present technology, there is provided an acoustic device to be worn on an ear for use, the acoustic device including a nozzle having a transducer installed therein, the transducer serving as a sound source, and a housing attached to a base portion of the nozzle and having an electronic circuit and a battery housed therein, the electronic circuit being configured to drive the transducer. When the acoustic device is worn on the ear with a distal end of the nozzle inserted into an earhole and the base portion of the nozzle positioned outside of the earhole, a passage continuously extending between the base portion and the distal end of the nozzle is secured to allow an external sound to be taken in through the passage.

The acoustic device according to the above embodiment of the present technology allows the external sound to be taken in with high sound quality, enabling sound image localization.

### BRIEF DESCRIPTION OF THE DRAWINGS

FIG. 1A is a left side view of an earphone according to a first embodiment of the present technology;

FIG. 1B is a front view of the earphone according to the first embodiment;

FIG. 1C is a right side view of the earphone according to the first embodiment;

FIG. 2A is a horizontal sectional view of the earphone according to the first embodiment;

FIG. 2B is a vertical sectional view of the earphone according to the first embodiment;

FIG. 3 is a perspective view illustrating a supporting board having a transducer mounted thereon;

FIG. 4A is a plan view of the transducer of the earphone according to the first embodiment;

FIG. 4B is a sectional view of the transducer of the earphone according to the first embodiment;

FIG. 5A is a plan view of a transducer of an earphone according to a first modification of the first embodiment;

FIG. 5B is a sectional view of the transducer of the earphone according to the first modification;

FIG. 6A is a plan view of a transducer of an earphone according to a second modification of the first embodiment;

FIG. 6B is a sectional view of the transducer of the earphone according to the second modification;

FIG. 7A is a left side view of an earphone according to a second embodiment of the present technology;

FIG. 7B is a front view of the earphone according to the second embodiment;

FIG. 7C is a right side view of the earphone according to the second embodiment;

FIG. 8A is a horizontal sectional view of the earphone according to the second embodiment; and

FIG. 8B is a vertical sectional view of the earphone according to the second embodiment.

### DETAILED DESCRIPTION OF THE PREFERRED EMBODIMENTS

Next, embodiments of the present technology will be described below with reference to the accompanying drawings. While acoustic devices to be worn on ears according to the embodiments of the present technology described below are assumed to be earphones, it is to be understood that acoustic devices according to embodiments of the present technology are not limited to earphones and may be other types of acoustic devices to be worn on ears, such as headphones. In the accompanying drawings described below, identical or like portions are designated by identical or like reference characters. It is to be appreciated, however, that the accompanying drawings represent merely schematic diagrams, and that the actual relation between the thickness and dimension in plan view of each component, for example, are not represented in the accompanying drawings. Therefore, its specific thickness and dimension should be determined with reference to the following descriptions. In addition, needless to say, the relation between the dimensions and the ratios therebetween may vary between different ones of the accompanying drawings.

Moreover, the embodiments described below are presented by way of example to illustrate the technical idea of the present technology in specific forms, and should not be construed to specify the materials, shapes, structures, arrangements, etc., of the components. Various modifications may be made to the embodiments on the basis of the configurations defined in the appended claims.

### First Embodiment

An earphone that is an acoustic device according to a first embodiment of the present technology includes a nozzle having a transducer installed therein, the transducer serving as a sound source, and a housing attached to a base portion of the nozzle and having an electronic circuit and a battery housed therein, the electronic circuit being configured to drive the transducer. When the earphone is worn on an ear with a distal end of the nozzle inserted into an earhole and the base portion of the nozzle positioned outside of the earhole, a passage continuously extending between the base portion and the distal end of the nozzle is secured to allow an external sound to be taken in through the passage. The external sound can be taken in with high sound quality through the passage continuously extending between the distal end of the nozzle and the base portion of the nozzle, which is positioned outside of the earhole.

The nozzle may have disposed therein a partition dividing an interior of the nozzle into a first passage and a second passage each extending in a direction in which the nozzle extends, the second passage being open at the base portion of the nozzle. Moreover, the transducer may be installed in the first passage, while the second passage may continuously extend from the base portion to the distal end of the nozzle to allow the external sound to be taken in through the second passage when the earphone is worn on the ear. The second passage, which allows the external sound to be taken in therethrough, is secured together with the first passage, which allows a sound wave produced from the transducer to be transmitted therethrough.

The second passage may have a cross-sectional area greater than a cross-sectional area of the first passage. This contributes to ensuring sufficient sound quality of the sound taken in through the second passage.

The earphone may further include an earpiece having flexibility and surrounding a predetermined range of the nozzle, the predetermined range extending from the distal end toward the base portion. Moreover, the nozzle may be capable of being fitted to the ear through the earpiece fitted into an ear canal through the earhole. This enables the nozzle to be stably fitted to the ear.

The transducer may include a board having a principal surface, a rear surface, and a recessed portion formed in the rear surface to enable the principal surface to vibrate in a separating/approaching direction; a diaphragm formed by a portion of the board which includes a portion of the principal surface and which has a predetermined thickness as a result of the recessed portion being formed in the rear surface; and a drive layer formed on the diaphragm at the principal surface and including a pair of electrode layers and a piezoelectric layer formed between the pair of electrode layers. Thus, the diaphragm can be caused to vibrate through the drive layer.

The diaphragm may be joined to the principal surface over an entire outer boundary thereof. This provides a sturdy structure with the diaphragm being joined to the principal surface over the entire outer boundary thereof.

The board may have a slit defined therein along a portion of the outer boundary of the diaphragm on the principal surface such that the diaphragm forms a cantilever. The cantilever structure enables an increase in the amplitude of the diaphragm and hence an increase in sound volume.

The board may have a side wall formed on the principal surface to surround the diaphragm. The side wall is able to protect the diaphragm and serve as a support to support the transducer from above.

The side wall may have an upper hood formed to project inward from a top portion of the side wall. The upper hood contributes to preventing dust from entering from above.

The earphone may further include a lower board attached to the rear surface and forming a lower hood projecting under the recessed portion. The lower hood contributes to preventing dust from entering from below.

The earphone may further include a supporting board having a principal surface, and the transducer may be attached to the principal surface of the supporting board and be installed in the nozzle through the supporting board. The supporting board supports the transducer and supplies a drive voltage to the transducer through wires.

The transducer may have an electronic circuit housed therein, and voltage for driving the drive layer may be supplied from this electronic circuit to the transducer through the supporting board. The voltage for driving the drive layer of the transducer is supplied from the electronic circuit through the supporting board.

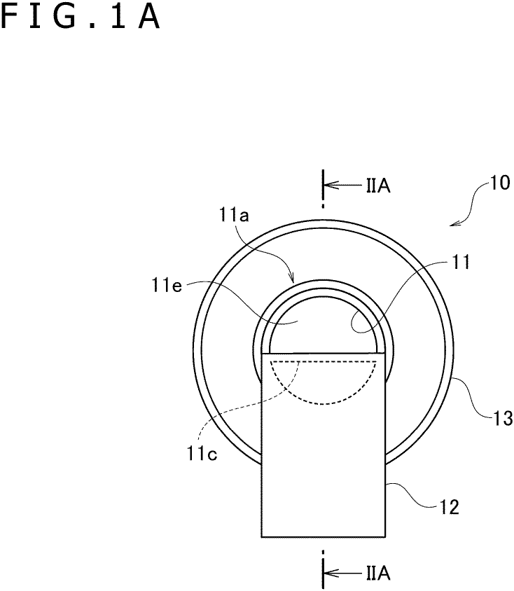

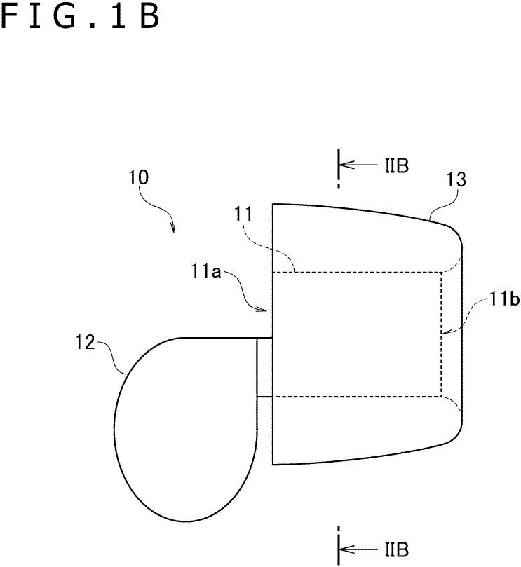

FIGS. 1A, 1B, and 1C are a left side view, a front view, and a right side view, respectively, of an earphone 10 according to the first embodiment of the present technology. It is assumed here for the sake of convenience that a front of the earphone 10 is illustrated in FIG. 1B. The earphone 10 according to the first embodiment includes a nozzle 11, a housing 12, and an earpiece 13. The nozzle 11 has a transducer installed therein, the transducer serving as a sound source, and extends from a base portion 11a which is to be positioned outside of an earhole, to a distal end 11b which is to be inserted into the earhole. The housing 12 is attached to the base portion 11a of the nozzle 11 and has an electronic circuit and a battery housed therein, the electronic circuit being configured to drive the transducer. The earpiece 13 has flexibility, is attached to the nozzle 11 in the vicinity of the distal end 11b, and is arranged to surround a predetermined range of the nozzle 11, the predetermined range extending from the distal end 11b toward the base portion 11a.

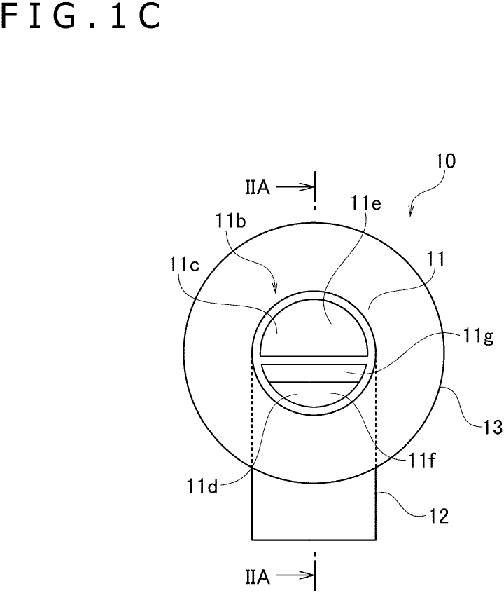

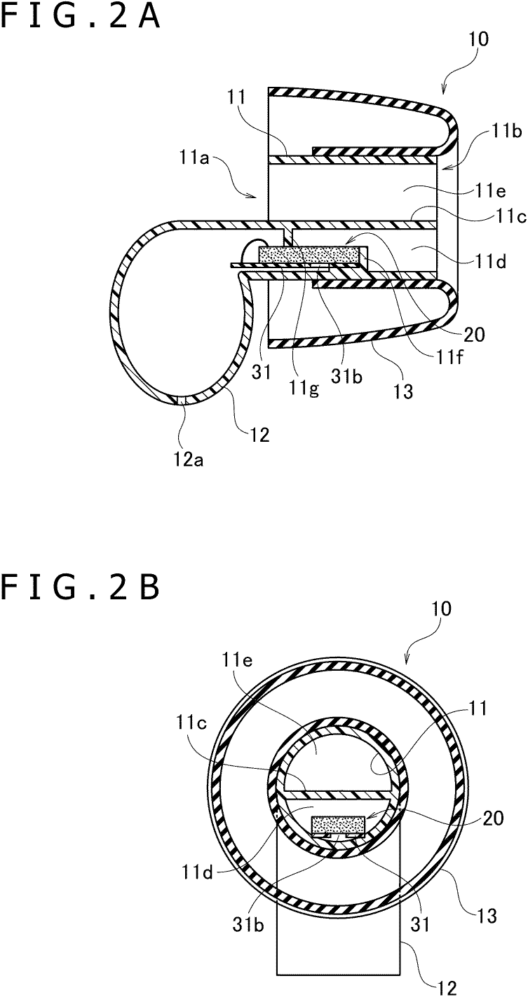

FIG. 2A is a sectional view of the earphone 10 taken along line IIA-IIA in FIG. 1A or FIG. 1C. FIG. 2B is a sectional view of the earphone 10 taken along line IIB-IIB in FIG. 1B. As illustrated in FIGS. 2A and 2B, the nozzle 11 has a cylindrical shape having a predetermined diameter and a predetermined wall thickness, and extends from the base portion 11a to the distal end 11b over a predetermined distance. A passage inside the nozzle 11 is divided by a partition 11c of the nozzle 11 having a predetermined thickness, into a first passage 11d and a second passage 11e. The second passage 11e is positioned above the first passage 11d and has a cross-sectional area greater than that of the first passage 11d. A transducer 20 is installed in the first passage 11d. The nozzle 11 may be made of an appropriate resin. Note that it is sufficient if the first passage 11d and the second passage 11e are passages divided by the partition 11c inside the nozzle 11, and that the first passage 11d and the second passage 11e may not necessarily be divided passages positioned one above the other. Also, note that the cross-sectional area of the second passage 11e may not necessarily be greater than the cross-sectional area of the first passage 11d.

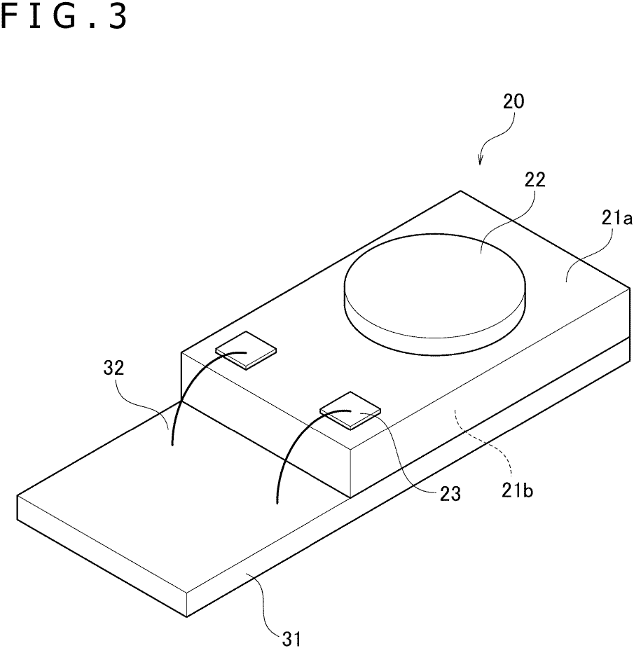

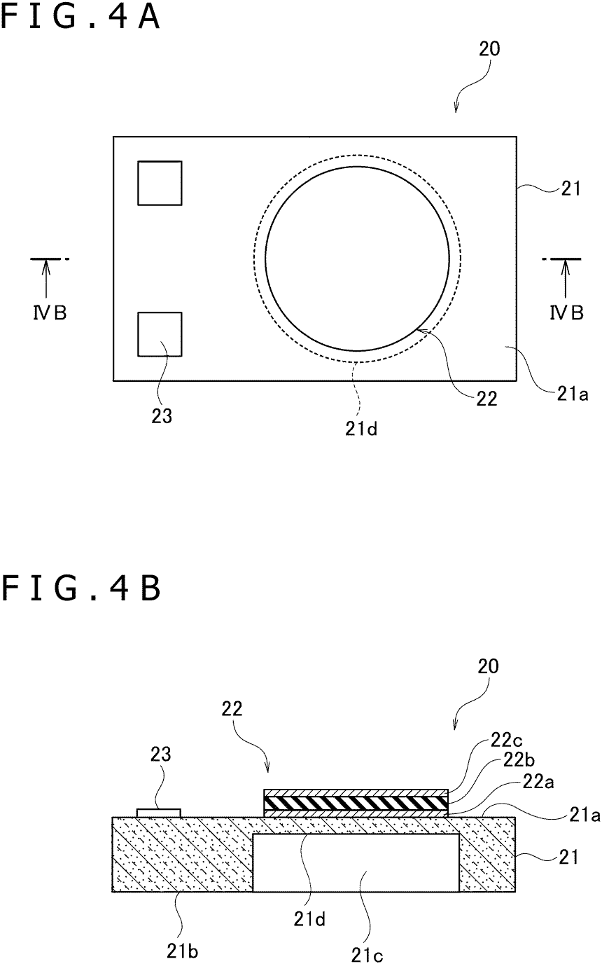

FIG. 3 is a perspective view of the transducer 20 supported by a supporting board 31. The transducer 20 is supported by the supporting board 31 and is thus installed in the first passage 11d of the nozzle 11. As illustrated in FIGS. 2A and 2B, the supporting board 31 is supported by a bottom portion of the first passage 11d, and first ends of the transducer 20 and the supporting board 31 are supported by a first supporting wall 11f which is formed at the bottom portion of the first passage 11d and which extends in a radial direction of the nozzle 11, while a part of a principal surface 21a which is adjacent to a second end opposite to the first end of the transducer 20 is supported by a second supporting wall 11g which is formed at a ceiling portion of the first passage 11d and which extends in the radial direction of the nozzle 11. The supporting board 31 has an air escape hole 31b formed under a diaphragm 21d and a recessed portion 21c of the transducer 20 to allow entrance and exit of air while the diaphragm 21d is vibrating (see FIGS. 4A and 4B) .

FIG. 4A is a plan view of the transducer 20. FIG. 4B is a sectional view of the transducer 20 taken along line IVB-IVB in FIG. 4A. The transducer 20 includes a plate-shaped board 21 made of silicon. The board 21 is substantially rectangular in a plan view and has a predetermined thickness. At the principal surface 21a of the board 21, the diaphragm 21d is formed by a portion of the board 21 having a predetermined thickness as a result of the recessed portion 21c being formed in a rear surface 21b, which is opposite to the principal surface 21a, of the board 21 to enable the principal surface 21a to vibrate in a separating/approaching direction. It is assumed here that vibrating in the separating/approaching direction means vibrating in a direction in which an object moves away from and closer to the principal surface 21a, i.e., along a normal to the principal surface 21a.

The diaphragm 21d is formed as a disk-shaped region having a predetermined diameter at a position displaced from a center of the principal surface 21a, which is substantially rectangular, toward a short side thereof on one side. A drive layer 22 which includes a pair of electrode layers, i.e., a lower electrode layer 22a and an upper electrode layer 22c, and a piezoelectric layer 22b formed therebetween is formed on the diaphragm 21d. The drive layer 22 forms a disk-shaped region having a diameter smaller than that of the diaphragm 21d and surrounded by an outer boundary of the diaphragm 21d. A pair of electrode pads 23 for supplying a drive voltage to the drive layer 22 are formed along another short side, which is opposite to the abovementioned short side on the one side.

The diaphragm 21d of the transducer 20 vibrates through driving by the drive layer 22 to produce a sound wave. The sound wave produced from the transducer 20 inside the nozzle 11 travels toward the distal end 11b of the nozzle 11 along the first passage 11d, and leaves the nozzle 11 through the distal end 11b. Along with the vibration of the diaphragm 21d, air goes in and out through the air escape hole 31b under the diaphragm 21d and the recessed portion 21c of the transducer 20. The transducer 20 may be installed at any desirable position in the first passage 11d of the nozzle 11, such as in the vicinity of the base portion 11a of the nozzle 11, in the vicinity of the distal end 11b of the nozzle 11, or in a middle of the nozzle 11.

Referring back to FIGS. 2A and 2B, the second passage 11e in an upper portion of the nozzle 11 forms a passage continuously extending from an opening at the base portion 11a of the nozzle 11 to the distal end 11b of the nozzle 11. When the earphone 10 is worn on an ear, a sound outside of the earphone 10 travels toward the distal end 11b of the nozzle 11 through the opening at the base portion 11a of the nozzle 11 and the second passage 11e, and leaves the nozzle 11 through the distal end 11b.

The housing 12 has the electronic circuit and the battery housed therein, the electronic circuit being for driving the transducer 20, the battery being for driving the electronic circuit. The electronic circuit may be provided with a radio amplifier that receives an external radio signal and that converts the received radio signal into voltage for driving the transducer 20. The housing 12 closes the first passage 11d below the partition 11c at the base portion 11a of the nozzle 11 while leaving the second passage 11e open at the base portion 11a of the nozzle 11, and further extends downward, with an air escape hole 12a defined in the lowermost portion of the housing 12. The housing 12 may be made of an appropriate resin and may be formed in one piece with the nozzle 11.

The earpiece 13 includes an inner cylinder fixed to the nozzle 11 while covering a predetermined range of the nozzle 11, the predetermined range extending from the distal end 11b toward the base portion 11a, and an outer cylinder extending from a predetermined position beyond the distal end 11b toward the base portion 11a while gradually increasing in diameter, and surrounding a predetermined range of the nozzle 11 wider than the predetermined range surrounded by the inner cylinder. The inner cylinder and the outer cylinder are formed in one piece, being joined to each other at the predetermined position. The earpiece 13 is made of a flexible material and has a predetermined wall thickness such that, when the earphone 10 is worn on the ear, the earpiece 13 can be fitted in the earhole and an ear canal to support the earphone 10 with appropriate elasticity. The earpiece 13 may be made of an appropriate resin, rubber, or other materials.

In the earphone 10 according to the first embodiment, an external sound taken in through the second passage 11e of the nozzle 11, as well as a sound wave originating from the transducer 20 installed in the first passage 11d of the nozzle 11, leaves the nozzle 11 through the distal end 11b thereof. Since the second passage 11e has a cross-sectional area greater than that of the first passage 11d, the external sound taken in through the opening at the base portion 11a of the nozzle 11 undergoes limited diffraction due to the second passage 11e, resulting in a reduced deterioration of sound quality. Therefore, the earphone 10 according to the present embodiment allows even the external sound to be taken in with high sound quality, enabling sound image localization.

In addition, in the earphone 10 according to the first embodiment, the transducer 20 in which the diaphragm 21d is driven through the drive layer 22 is used as the sound source. The transducer 20 is small in size and weight because the transducer 20 is manufactured by using a silicon board and the MEMS technology. Accordingly, the transducer 20 can be installed in the first passage 11d of the nozzle 11, enabling not only the nozzle 11 but also the earphone 10 as a whole to be small in size and weight. Moreover, the transducer 20 is piezoelectrically driven and has a low power consumption. This enables the earphone 10 to be used for a long time.

Further, since the earphone 10 according to the first embodiment allows an external sound to be taken in with high sound quality, a known method of letting a hearing-impaired person hear natural sounds to reduce tinnitus can be adopted with the earphone 10 worn on the ear.

### First Modification

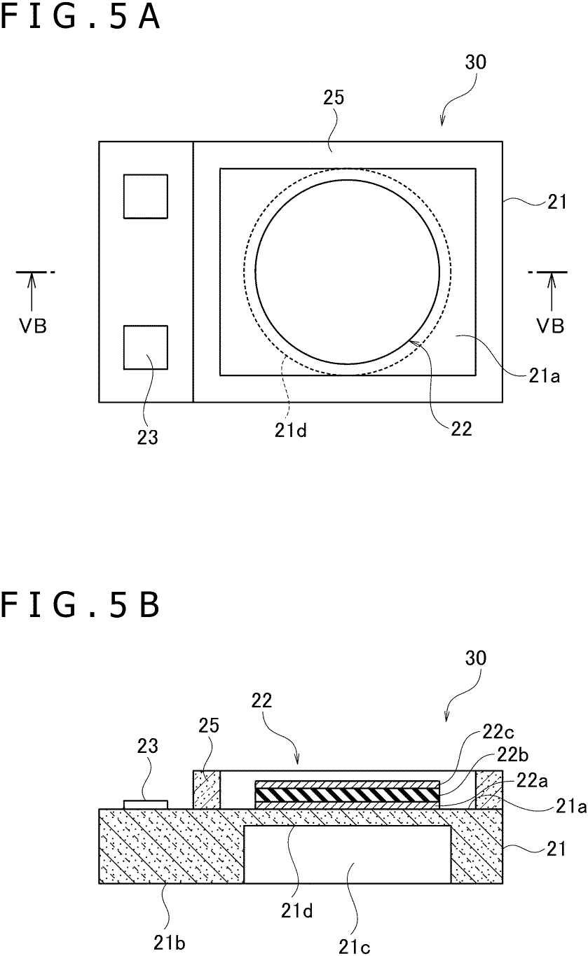

FIG. 5A is a plan view of a transducer 30 according to a first modification of the first embodiment. FIG. 5B is a sectional view of the transducer 30 taken along line VB-VB in FIG. 5A. The transducer 30 according to the first modification is different from the transducer 20 according to the first embodiment in that a side wall 25 is formed on a principal surface 21a of a board 21 to surround a diaphragm 21d. The transducer 30 according to the first modification is otherwise similar in structure to the transducer 20 according to the first embodiment, and accordingly, like members or portions are designated by like reference numerals to clarify correspondences therebetween.

The transducer 30 according to the first modification includes the plate-shaped board 21 made of silicon. The board 21 is substantially rectangular in a plan view and has a predetermined thickness. At the principal surface 21a of the board 21, the diaphragm 21d is formed by a portion of the board 21 having a predetermined thickness as a result of a recessed portion 21c being formed in a rear surface 21b, which is opposite to the principal surface 21a, of the board 21 to enable the principal surface 21a to vibrate in the separating/approaching direction.

The diaphragm 21d is formed as a disk-shaped region having a predetermined diameter at a position displaced from a center of the principal surface 21a, which is substantially rectangular, toward a short side thereof on one side. A drive layer 22 which includes a pair of electrode layers, i.e., a lower electrode layer 22a and an upper electrode layer 22c, and a piezoelectric layer 22b formed therebetween is formed on the diaphragm 21d. The drive layer 22 forms a disk-shaped region having a diameter smaller than that of the diaphragm 21d and surrounded by an outer boundary of the diaphragm 21d. A pair of electrode pads 23 for supplying a drive voltage to the drive layer 22 are formed along another short side, which is opposite to the abovementioned short side on the one side.

The side wall 25, which has a predetermined thickness and a predetermined height, is formed on the principal surface 21a of the board 21 to surround the diaphragm 21d and the drive layer 22 formed on the diaphragm 21d. Portions of the side wall 25 extend along an outer perimeter of the principal surface 21a, over the abovementioned short side on the one side and over a predetermined range of each of a pair of long sides facing each other, the predetermined range extending from the abovementioned short side on the one side. A remaining portion of the side wall 25 extends in parallel with another short side on an opposite side between the electrode pads 23 and the diaphragm 21d, and is joined to the portions of the side wall 25 which extend along the outer perimeter along the pair of long sides. The side wall 25 may be formed by, for example, another silicon board attached to the board 21, or may be formed as an integral portion of the board 21 through etching.

In the transducer 30 according to the first modification, the side wall 25 has the predetermined height and is formed to surround the drive layer 22 and the diaphragm 21d on the principal surface 21a. The diaphragm 21d and the drive layer 22 are thus protected from above. In addition, the side wall 25 has the predetermined height from the principal surface 21a to a top portion thereof, which is sufficient to enable the side wall 25 to serve as a support when the transducer 30 is supported from above.

### Second Modification

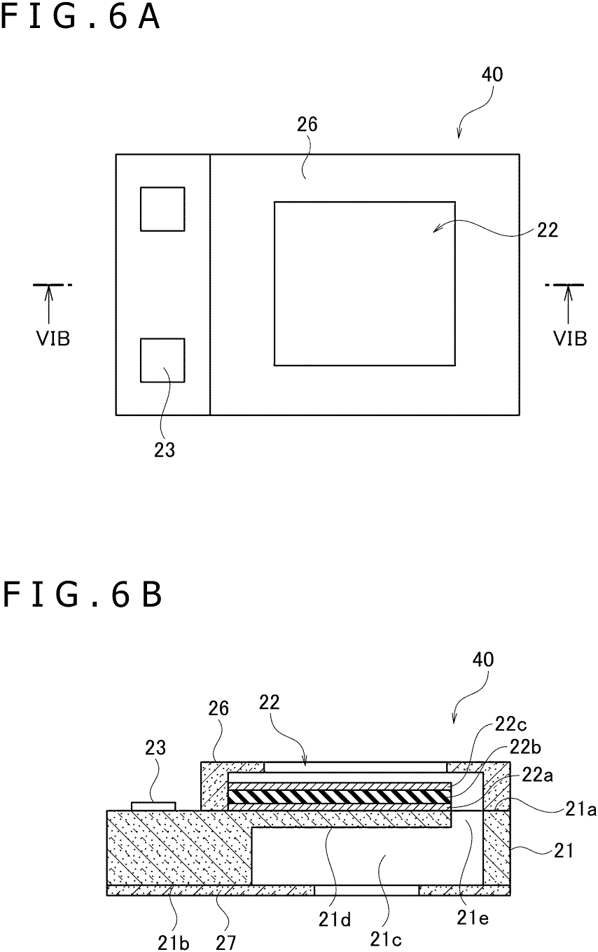

FIG. 6A is a plan view of a transducer 40 according to a second modification of the first embodiment. FIG. 6B is a sectional view of the transducer 40 taken along line VIB-VIB in FIG. 6A. The transducer 40 according to the second modification is different from the transducer 20 according to the first embodiment in that a diaphragm 21d has a cantilever structure, a side wall 26 is formed on a principal surface 21a of a board 21 to surround the diaphragm 21d, and a lower board 27 is attached to a rear surface 21b of the board 21. The transducer 40 according to the second modification is otherwise similar in structure to the transducer 20 according to the first embodiment, and accordingly, like members or portions are designated by like reference numerals to clarify correspondences therebetween.

The transducer 40 according to the second modification includes the plate-shaped board 21 made of silicon. The board 21 is substantially rectangular in a plan view and has a predetermined thickness. At the principal surface 21a of the board 21, the diaphragm 21d is formed by a portion of the board 21 having a predetermined thickness as a result of a recessed portion 21c being formed in the rear surface 21b, which is opposite to the principal surface 21a, of the board 21 to enable the principal surface 21a to vibrate in the separating/approaching direction.

The diaphragm 21d is formed as a substantially rectangular region at a position displaced from a center of the principal surface 21a, which is substantially rectangular, toward a short side thereof on one side, the substantially rectangular region having sides parallel to corresponding sides of the substantially rectangular principal surface 21a. A slit 21e is defined along three sides of the diaphragm 21d, including a short side opposite to the abovementioned short side on the one side and long sides facing each other, so that the diaphragm 21d has the cantilever structure. A drive layer 22 which includes a pair of electrode layers, i.e., a lower electrode layer 22a and an upper electrode layer 22c, and a piezoelectric layer 22b formed therebetween is formed on the diaphragm 21d. The drive layer 22 forms a substantially rectangular region having an area smaller than that of the diaphragm 21d and surrounded by an outer boundary of the diaphragm 21d. A pair of electrode pads 23 for supplying a drive voltage to the drive layer 22 are formed along another short side, which is opposite to the abovementioned short side on the one side.

The side wall 26, which has a predetermined thickness and a predetermined height, is formed on the principal surface 21a of the board 21 to surround the diaphragm 21d and the drive layer 22 formed on the diaphragm 21d. Portions of the side wall 26 extend along an outer perimeter of the principal surface 21a, over the abovementioned short side on the one side and over a predetermined range of each of a pair of long sides facing each other, the predetermined range extending from the abovementioned short side on the one side. A remaining portion of the side wall 26 extends in parallel with another short side on an opposite side between the electrode pads 23 and the diaphragm 21d, and is joined to the portions of the side wall 26 which extend along the outer perimeter along the pair of long sides. The side wall 26 forms a hood projecting inward from a top portion thereof over a predetermined distance. The side wall 26 may be formed by, for example, another silicon board attached to the board 21.

The lower board 27, which has a predetermined thickness, is attached to the rear surface 21b of the board 21. Similarly to the rear surface 21b having the recessed portion 21c formed therein, the lower board 27 has defined therein a hole having a substantially rectangular outer perimeter and corresponding to the recessed portion 21c. The lower board 27 forms a hood projecting from a perimeter of the recessed portion 21c over a predetermined distance under the recessed portion 21c. The lower board 27 may be formed by a silicon board, a printed circuit board, or other boards attached to the board 21.

In the transducer 40 according to the second modification, the side wall 26 has the predetermined height and is formed to surround the drive layer 22 and the diaphragm 21d on the principal surface 21a, and the diaphragm 21d and the drive layer 22 are thus protected from above. In addition, in the second modification, the diaphragm 21d has the cantilever structure with the slit 21e defined in the board 21, and presence of dust becomes a problem, but the hood of the side wall 26 contributes to preventing dust from entering from above. Further, the side wall 26 has the predetermined height from the principal surface 21a to the top portion thereof, which is sufficient to enable the side wall 26 to serve as a support when the transducer 40 is supported from above.

In addition, in the transducer 40 according to the second modification, the lower board 27 is attached to the rear surface 21b, with the hood of the lower board 27 projecting under the recessed portion 21c. As described above, the diaphragm 21d according to the second modification has the cantilever structure with the slit 21e defined in the board 21, and the presence of dust becomes a problem, but the hood of the lower board 27 contributes to preventing dust from entering from below.

### Second Embodiment

An earphone that is an acoustic device according to a second embodiment of the present technology includes a nozzle having a transducer installed therein, the transducer serving as a sound source, and a housing attached to a base portion of the nozzle and having an electronic circuit and a battery housed therein, the electronic circuit being configured to drive the transducer. When the earphone is worn on an ear with a distal end of the nozzle inserted into an earhole and the base portion of the nozzle positioned outside of the earhole, a passage continuously extending between the base portion and the distal end of the nozzle is secured to allow an external sound to be taken in through the passage. The external sound can be taken in with high sound quality through this passage.

The nozzle may be arranged to secure the passage continuously extending between the base portion and the distal end of the nozzle, outside of the nozzle along an ear canal, and occupy only a part of a cross-section of the ear canal to allow the external sound to be taken in through the passage when the earphone is worn on the ear, the passage being open at the base portion. The passage outside of the nozzle is secured to allow the external sound to be taken in therethrough.

The transducer may include a board having a principal surface, a rear surface, and a recessed portion formed in the rear surface to enable the principal surface to vibrate in a separating/approaching direction; a diaphragm formed by a portion of the board which includes a portion of the principal surface and which has a predetermined thickness as a result of the recessed portion being formed in the rear surface; and a drive layer formed on the diaphragm at the principal surface and including a pair of electrode layers and a piezoelectric layer formed between the pair of electrode layers. The diaphragm can be caused to vibrate through the drive layer.

The diaphragm may be joined to the principal surface over an entire outer boundary thereof. This provides a sturdy structure with the diaphragm being joined to the principal surface over the entire outer boundary thereof.

The board may have a slit defined therein along a portion of the outer boundary of the diaphragm on the principal surface such that the diaphragm forms a cantilever. The cantilever structure enables an increase in the amplitude of the diaphragm and hence an increase in sound volume.

The board may have a side wall formed on the principal surface to surround the diaphragm. The side wall is able to protect the diaphragm and serve as a support to support the transducer from above.

The side wall may have an upper hood formed to project inward from a top portion of the side wall. The upper hood contributes to preventing dust from entering from above.

The earphone may further include a lower board attached to the rear surface and forming a lower hood projecting under the recessed portion. The lower hood contributes to preventing dust from entering from below.

The earphone may further include a supporting board having a principal surface, and the transducer may be attached to the principal surface of the supporting board and be installed in the nozzle through the supporting board. The supporting board supports the transducer and supplies a drive voltage to the transducer through wires.

The transducer may have an electronic circuit housed therein, and voltage for driving the drive layer may be supplied from this electronic circuit to the transducer through the supporting board. The voltage for driving the drive layer of the transducer is supplied from the electronic circuit through the supporting board.

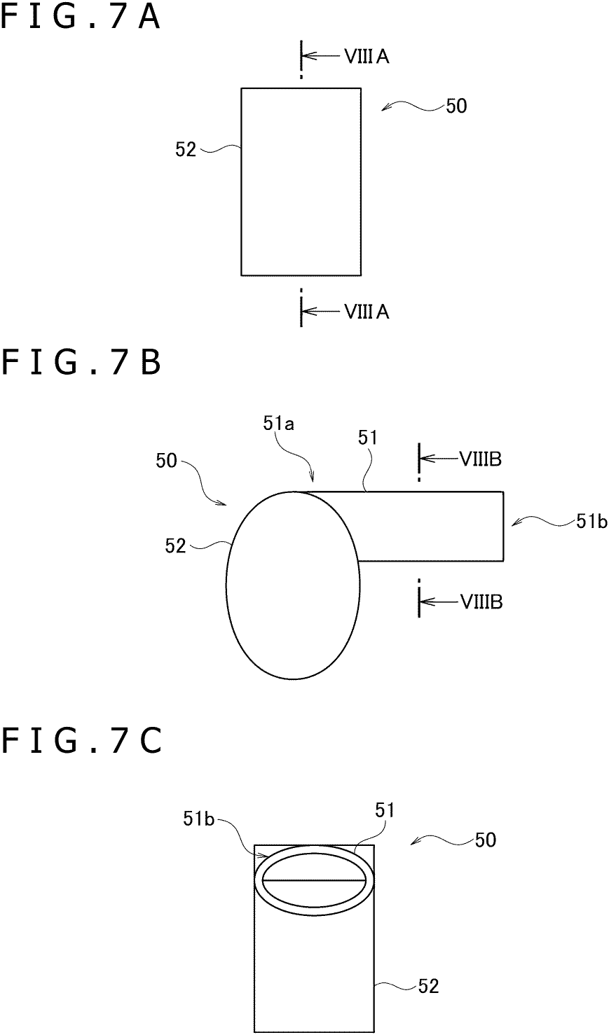

FIGS. 7A, 7B, and 7C are a left side view, a front view, and a right side view, respectively, of an earphone 50 according to the second embodiment of the present technology. The earphone 50 according to the second embodiment is different from the earphone 10 according to the first embodiment in the structures of a nozzle 51 and a housing 52 and in that the earphone 50 is not provided with the earpiece 13. The earphone 50 according to the second embodiment is otherwise similar in structure to the earphone 10 according to the first embodiment, and accordingly, like members or portions are designated by like reference numerals to clarify correspondences therebetween.

The earphone 50 according to the second embodiment includes the nozzle 51 and the housing 52. The nozzle 51 has a transducer installed therein, the transducer serving as a sound source, and extends from a base portion 51a to a distal end 51b thereof. The housing 52 is attached to the base portion 51a of the nozzle 51 and has an electronic circuit and a battery housed therein, the electronic circuit being configured to drive the transducer.

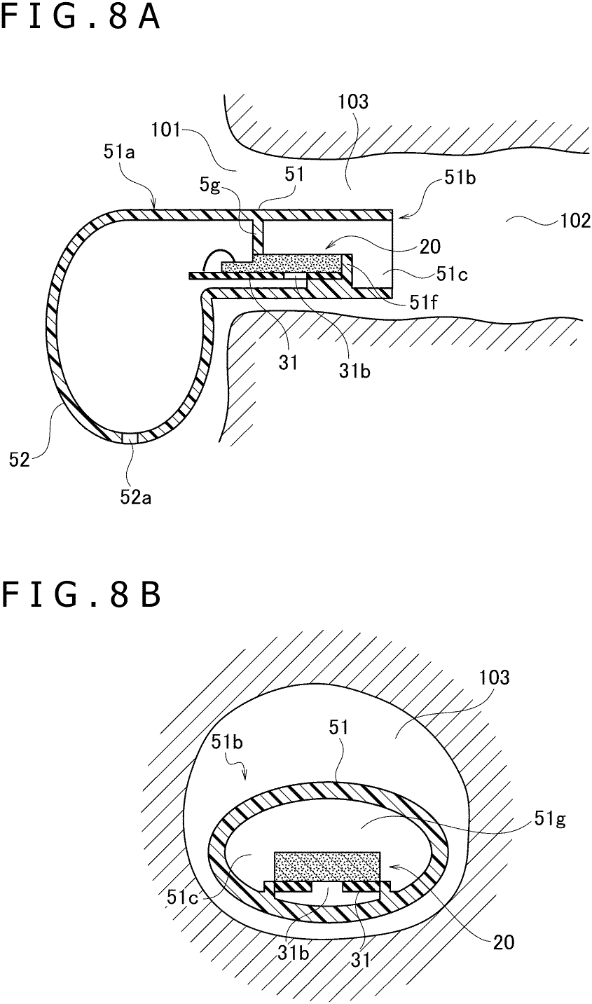

FIG. 8A represents a sectional view of the earphone 50 taken along line VIIIA-VIIIA in FIG. 7A or FIG. 7C. FIG. 8B represents a sectional view of the earphone 50 taken along line VIIIB-VIIIB in FIG. 7B. Note that an earhole 101 and a portion of an ear canal 102 which is in contact with the earphone 50 when the earphone 50 is worn on an ear are depicted in FIGS. 8A and 8B. As illustrated in FIGS. 8A and 8B, the nozzle 51 is a hollow elliptical tube that has a cross-section having a predetermined major axis and a predetermined minor axis, with the major axis extending in one direction such as a horizontal direction. The nozzle 51 extends from the base portion 51a to the distal end 51b over a predetermined distance. A transducer 20 is installed in a passage 51c inside the nozzle 51. The nozzle 51 may be made of an appropriate resin.

The nozzle 51 is arranged to secure a passage 103 having a predetermined cross-sectional area between an outer circumference of the nozzle 51 and a wall of the earhole 101 or the ear canal 102 when the earphone 50 is worn on the ear. For example, the nozzle 51 may have a cross-sectional area smaller than the cross-sectional area of the passage 103. The passage 103 continuously extends from the earhole 101 to a portion of the ear canal 102 at the distal end 51b of the nozzle 51 along the outer circumference of the nozzle 51. A space outside of the earphone 50 and the portion of the ear canal 102 at the distal end 51b of the nozzle 51 are in communication with each other through the passage 103. Note that the earphone 50 may be worn on the ear with a hook, which is not illustrated in the figures, held on the ear, for example.

Reference is made back to FIG. 3. Also, in the second embodiment, the transducer 20 is supported by a supporting board 31. The transducer 20 is installed in the passage 51c of the nozzle 51 with the supporting board 31 supporting the transducer 20. As illustrated in FIGS. 8A and 8B, the supporting board 31 is supported by a bottom portion of the passage 51c, and first ends of the transducer 20 and the supporting board 31 are supported by a first supporting wall 51f which is formed at the bottom portion of the passage 51c and which extends in a radial direction of the nozzle 51, while a part of a principal surface 21a which is adjacent to a second end opposite to the first end of the transducer 20 is supported by a second supporting wall 51g which is formed at a ceiling portion of the passage 51c and which extends in the radial direction of the nozzle 51. The supporting board 31 has an air escape hole 31b formed under a diaphragm 21d and a recessed portion 21c of the transducer 20 to allow entrance and exit of air while the diaphragm 21d is vibrating.

Reference is made back to FIGS. 4A and 4B. The transducer 20 according to the second embodiment has a structure similar to that of the transducer according to the first embodiment. The transducer 20 includes a plate-shaped board 21 made of silicon. The board 21 is substantially rectangular in a plan view and has a predetermined thickness. At the principal surface 21a of the board 21, the diaphragm 21d is formed by a portion of the board 21 having a predetermined thickness as a result of the recessed portion 21c being formed in a rear surface 21b, which is opposite to the principal surface 21a, of the board 21 to enable the principal surface 21a to vibrate in the separating/approaching direction.

The diaphragm 21d is formed as a disk-shaped region having a predetermined diameter at a position displaced from a center of the principal surface 21a, which is substantially rectangular, toward a short side thereof on one side. A drive layer 22 which includes a pair of electrode layers, i.e., a lower electrode layer 22a and an upper electrode layer 22c, and a piezoelectric layer 22b formed therebetween is formed on the diaphragm 21d. The drive layer 22 forms a disk-shaped region having a diameter smaller than that of the diaphragm 21d and surrounded by an outer boundary of the diaphragm 21d.

The diaphragm 21d of the transducer 20 vibrates through driving by the drive layer 22 to produce a sound wave. The sound wave produced from the transducer 20 inside the nozzle 51 travels toward the distal end 51b of the nozzle 51 along the passage 51c, and leaves the nozzle 51 through the distal end 51b. Along with the vibration of the diaphragm 21d, air goes in and out through the air escape hole 31b under the diaphragm 21d and the recessed portion 21c of the transducer 20. The transducer 20 may be installed at any desirable position in the passage 51c of the nozzle 51, such as in a middle of the nozzle 51, in the vicinity of the distal end 51b of the nozzle 51, or in the vicinity of the base portion 51a.

The housing 52 has the electronic circuit and the battery housed therein, the electronic circuit being for driving the transducer 20, the battery being for driving the electronic circuit. The electronic circuit may be provided with a radio amplifier that receives an external radio signal and that converts the received radio signal into voltage for driving the transducer 20. The housing 52 closes the passage 51c at the base portion 51a of the nozzle 51, and further extends downward, with an air escape hole 52a defined in the lowermost portion of the housing 52. The housing 52 may be made of an appropriate resin and may be formed in one piece with the nozzle 51.

Note that, in the earphone 50 according to the second embodiment, as in the earphone 10 according to the first embodiment, the transducer 30 according to the first modification or the transducer 40 according to the second modification may be used in place of the transducer 20.

In the earphone 50 according to the second embodiment, a sound wave originating from the transducer 20 installed in the passage 51c of the nozzle 51 leaves the nozzle 51 through the distal end 51b, while an external sound is taken in through the passage 103 defined between the outer circumference of the nozzle 51 and the wall of the earhole 101 or the ear canal 102. The passage 103 defined between the outer circumference of the nozzle 51 and the wall of the earhole 101 or the ear canal 102 lies outside of the nozzle 51 and has a sufficient cross-sectional area to reduce a deterioration of sound quality. Therefore, the earphone 50 according to the second embodiment allows even the external sound to be taken in with high sound quality, enabling sound image localization of the external sound.

In addition, in the earphone 50 according to the second embodiment, the transducer 20 in which the diaphragm 21d is driven through the drive layer 22 is used as the sound source. The transducer 20 is small in size and weight and is installed in the passage 51c of the nozzle 51. This enables not only the nozzle 51, in which the transducer 20 is installed, but also the earphone 50 as a whole to be small in size and weight. Moreover, the transducer 20 is piezoelectrically driven and has a low power consumption. This enables the earphone 50 to be used for a long time.

Furthermore, the earphone 50 according to the second embodiment allows an external sound to be taken in with high sound quality. Thus, even when a hearing-impaired person in acoustic therapy is constantly hearing environmental sound such as a murmur of a stream through the earphone 50 to reduce tinnitus by alleviating auditory tension, the hearing-impaired person is able to hear an external sound. In addition, the earphone 50 according to the second embodiment does not close the earhole 101, which reduces a burden imposed on the ear when the earphone 50 is worn on the ear.

While embodiments of the present technology have been described above, it is to be understood that the foregoing description and the accompanying drawings, which form a part of this disclosure, are illustrative and not restrictive. Various alternative embodiments, implementations, and operational techniques will be apparent to those skilled in the art from this disclosure.

For example, while the earphones have been described above as examples of acoustic devices according to embodiments of the present technology, it will be understood that acoustic devices according to embodiments of the present technology are not limited to earphones and may include other types of acoustic devices such as headphones. Headphones according to embodiments of the present technology may include closed-back headphones that cover ears, on-ear headphones that are held to ears, and other headphones. Generally speaking, it may be sufficient if acoustic devices according to embodiments of the present technology include a nozzle having a distal end to be inserted into an earhole, and a housing that lies in the vicinity of the nozzle.

In addition, while the transducers manufactured by using the MEMS technology have been described above as examples of the sound sources according to embodiments of the present technology, it will be understood that transducers according to embodiments of the present technology are not limited to such transducers. Transducers according to embodiments of the present technology may include other types of transducers such as voice-coil transducers or balanced-armature transducers.

What is claimed is:

1. An acoustic device to be worn on an ear for use, the acoustic device comprising:
a nozzle having a transducer installed therein, the transducer serving as a sound source; and
a housing attached to a base portion of the nozzle and having an electronic circuit and a battery housed therein, the electronic circuit being configured to drive the transducer, wherein
when the acoustic device is worn on the ear with a distal end of the nozzle inserted into an earhole and the base portion of the nozzle positioned outside of the earhole, a passage continuously extending between the base portion and the distal end of the nozzle is secured to allow an external sound to be taken in through the passage.

2. The acoustic device according to claim 1, wherein
the nozzle has a partition disposed therein, the partition dividing an interior of the nozzle into a first passage and a second passage each extending in a direction in which the nozzle extends, the second passage being open at the base portion of the nozzle, and
the transducer is installed in the first passage, and the second passage continuously extends from the base portion to the distal end of the nozzle to allow the external sound to be taken in through the second passage when the acoustic device is worn on the ear.

3. The acoustic device according to claim 2, wherein
the second passage has a cross-sectional area greater than a cross-sectional area of the first passage.

4. The acoustic device according to claim 2, further comprising:
an earpiece having flexibility and surrounding a predetermined range of the nozzle, the predetermined range extending from the distal end toward the base portion, wherein
the nozzle is capable of being fitted to the ear through the earpiece fitted into an ear canal through the earhole.

5. The acoustic device according to claim 1, wherein
the nozzle is arranged to secure the passage continuously extending between the base portion and the distal end of the nozzle outside of the nozzle along an ear canal, and occupy only a part of a cross-section of the ear canal to allow the external sound to be taken in through the passage when the acoustic device is worn on the ear, the passage being open at the base portion.

6. The acoustic device according to claim 1, wherein
the transducer includes
a board having a principal surface, a rear surface, and a recessed portion formed in the rear surface to enable the principal surface to vibrate in a separating/approaching direction,
a diaphragm formed by a portion of the board that includes a portion of the principal surface and has a predetermined thickness as a result of the recessed portion being formed in the rear surface, and
a drive layer formed on the diaphragm at the principal surface and including a pair of electrode layers and a piezoelectric layer formed between the pair of electrode layers.

7. The acoustic device according to claim 6, wherein
the diaphragm is joined to the principal surface over an entire outer boundary of the diaphragm.

8. The acoustic device according to claim 6, wherein
the board has a slit defined therein along a portion of an outer boundary of the diaphragm on the principal surface such that the diaphragm forms a cantilever.

9. The acoustic device according to claim 6, wherein
the board has a side wall formed on the principal surface to surround the diaphragm.

10. The acoustic device according to claim 9, wherein
the side wall has an upper hood formed to project inward from a top portion of the side wall.

11. The acoustic device according to claim 6, further comprising:
a lower board attached to the rear surface and forming a lower hood projecting under the recessed portion.

12. The acoustic device according to claim 6, further comprising:
a supporting board having a principal surface, wherein
the transducer is attached to the principal surface of the supporting board and is installed in the nozzle through the supporting board.

13. The acoustic device according to claim 12, wherein
the transducer has an electronic circuit housed therein, and voltage to be used for driving the drive layer is supplied from the electronic circuit to the transducer through the supporting board.
